(19) United States
(12) Patent Application Publication
(10) Pub. No.: US 2015/0003125 A1
(43) Pub. Date: Jan. 1, 2015

(54) POWER SUPPLY HAVING SURGE PROTECTION CIRCUIT

(71) Applicant: SAMSUNG ELECTRO-MECHANICS CO., LTD., Suwon (KR)

(72) Inventors: Kang Hee LEE, Seoul (KR); Jun Woo PARK, Seoul (KR); Sung Soo HONG, Seoul (KR); Jae Sun WON, Suwon (KR); Dong Kyun RYU, Suwon (KR); Seung Wan YU, Suwon (KR); Seung Ho HAN, Suwon (KR); Hwa Hun CHIN, Suwon (KR)

(73) Assignee: SAMSUNG ELECTRO-MECHANICS CO., LTD., Suwon (KR)

(21) Appl. No.: 14/055,408

(22) Filed: Oct. 16, 2013

(30) Foreign Application Priority Data
Jul. 1, 2013 (KR) 10-2013-0076497

(51) Int. Cl. H02M 1/32; H02M 1/44; H02H 9/00

(52) U.S. Cl. CPC H02M 1/32; H02H 9/005; H02M 1/44
USPC 363/44; 363/53

(57) ABSTRACT

There is provided a power supply having a surge protection circuit for protecting a product from a power surge by way of efficiently discharging a surge voltage or a surge current introduced through AC input power terminals to be applied to the product during the use of the product. The power supply having a surge protection circuit includes a discharging unit having discharge patterns disposed between power lines of input power terminals to discharge a surge voltage introduced into each of the power lines of the input power terminals; and a power supplying unit converting the power input via the input power terminals into predetermined power to supply the converted power.

### CROSS-REFERENCE TO RELATED APPLICATIONS

This application claims the priority of Korean Patent Application No. 10-2013-0076497 filed on Jul. 1, 2013, in the Korean Intellectual Property Office, the disclosure of which is incorporated herein by reference.

### BACKGROUND OF THE INVENTION

1. Field of the Invention

The present invention relates to a power supply having a surge protection circuit for protecting a product from power surges.

2. Description of the Related Art

Recently, as display devices have become increasingly larger, a lot of attention has been paid to flat panel displays (FPDs). Such an FPD product essentially includes a power supply for supplying power required for the operation thereof.

The power supply used in a FPD product converts alternating current (AC) power into a direct current (DC) power having a predetermined level to supply the converted DC power to circuits in the FPD product. If a surge voltage or a surge current is input to an AC input terminal due to a lightning strike or the switching of a power system, electronic components within a FPD product may be broken, electric electronic equipment may be critically damaged, and a software program may malfunction, thereby causing serious problems.

In order to overcome such problems, research into a surge protection circuit able to protect internal components by blocking a surge input to power supply is being actively undertaken. To this end, most power supplies have a surge absorber mounted on AC power input terminals to configure a protection circuit for protecting circuits from a surge. However, such a surge absorber is relatively expensive compared to other passive elements, and thus increases the final cost of products.

### RELATED ART DOCUMENT

### (Patent Document 1) Korean Patent Laid-open Publication No. 10-2007-0097170

### SUMMARY OF THE INVENTION

An aspect of the present invention provides a power supply having a surge protection circuit for protecting a product from a power surge by way of efficiently discharging a surge voltage or a surge current introduced through AC input power terminals to be applied to the product during the use of the product.

According to an aspect of the present invention, there is provided a power supply having a surge protection circuit, including: a discharging unit having discharge patterns disposed between power lines of input power terminals to discharge a surge voltage introduced into each of the power lines of the input power terminals; and a power supplying unit converting the power input via the input power terminals into predetermined power to supply the converted power.

The input power terminals may include a live terminal, a neutral terminal and a field ground terminal.

The discharging unit may include: a first discharge pattern arc-discharging a surge voltage between the live terminal and the neutral terminal; a second discharge pattern arc-discharging a surge voltage between the live terminal and the field ground terminal; and a third discharge pattern arc-discharging a surge voltage between the neutral terminal and the field ground terminal.

The first discharge pattern may include : a first pattern formed at the live terminal; and a second pattern formed at the neutral terminal and spaced apart from the first pattern by a predetermined distance so as to arc-discharge a surge voltage.

The second discharge pattern may include: a third pattern formed at the live terminal; and a fourth pattern formed at the field ground terminal and spaced apart from the third pattern by a predetermined distance so as to arc-discharge a surge voltage.

The third discharge pattern may include : a fifth pattern formed at the neutral terminal; and a sixth pattern formed at the field ground terminal and spaced apart from the fifth pattern by a predetermined distance so as to arc-discharge a surge voltage.

The power supply may further include a filter unit connected to the discharging unit so as to filter common mode noise in the power lines of the input power terminals. The filter unit may discharge a surge voltage flowing in the live terminal and that flowing in the neutral terminal.

The filter unit may include: a common mode filter having a first inductor electrically connected to the live terminal and the power supplying unit and a second inductor electrically connected to the neutral terminal and the power supplying unit, and filtering electromagnetic interference in a common mode of the input power terminals and the power supplying unit; a first y capacitor connected to the live terminal and the ground to filter electromagnetic interference in the common mode of the input power terminals and the power supplying unit; a second y capacitor connected to the neutral terminal and the ground to filter electromagnetic interference in the common mode of the input power terminals and the power supplying unit; a fourth discharge pattern having a seventh pattern formed at one terminal of the first inductor and an eighth pattern formed at the other end of the first inductor and spaced apart from the seventh pattern by a predetermined distance so as to arc-discharge a surge voltage flowing in the live terminal; and a fifth discharge pattern having a ninth pattern formed at one terminal of the second inductor and a tenth pattern formed at the other end of the second inductor and spaced apart from the ninth pattern by a predetermined distance so as to arc-discharge a surge voltage flowing in the neutral terminal.

The first y capacitor and the second y capacitor may provide discharge paths for the surge voltage.

The power supply may further include a rectifier rectifying the power from which electromagnetic interference has been filtered by the filter unit.

According to another aspect of the present invention, there is provided a power supply having a surge protection circuit, including: a discharging unit having discharge patterns disposed between power lines of input power terminals to discharge a surge voltage introduced into each of the power lines of the input power terminals; a filter unit connected to the discharging unit to filter common mode noise in the power lines of the input power terminals, and providing discharge paths for surge voltages flowing in the power lines of the input power terminals; and a power supplying unit converting the filtered power into predetermined power to supply the converted power.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram schematically illustrating a power supply having a surge protection circuit according to an embodiment of the present invention;

FIGS. 2 and 3 are circuit diagrams, each schematically illustrating a discharge path for a surge in the power supply having a surge protection circuit according to an embodiment of the present invention;

FIGS. 4 and 5 are photographs of printed circuit boards in which a power supply having a surge protection circuit according to an embodiment of the present invention is actually implemented; and

FIGS. 6A and 6B are photographs of printed circuit boards in which a power supply according to the related art and a power supply having a surge protection circuit according to an embodiment of the present invention are actually implemented.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

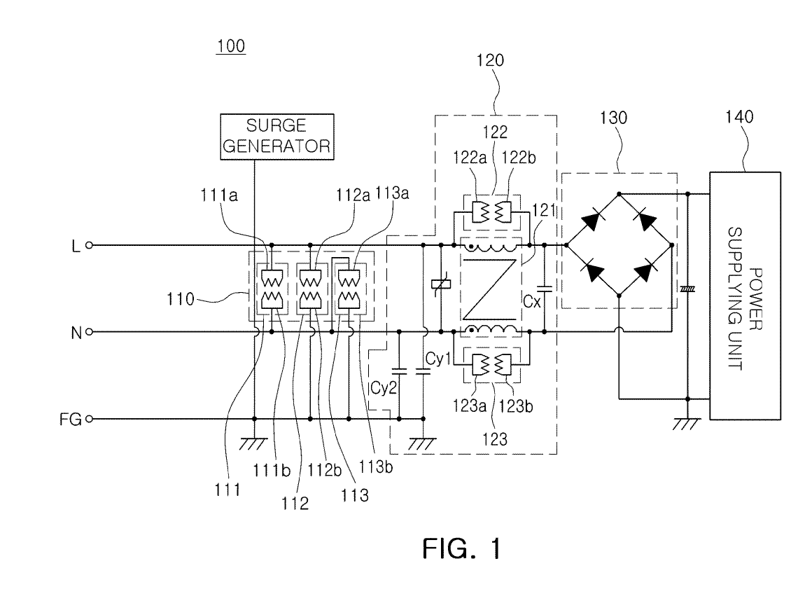

FIG. 1 is a circuit diagram schematically illustrating a power supply having a surge protection circuit according to an embodiment of the present invention.

Referring to FIG. 1, the power supply 100 having the surge protection circuit according to the embodiment may include a discharging unit 110, a filter unit 120, a rectifying unit 130 and a power supplying unit 140.

The discharging unit 110 may discharge the energy of a surge voltage by arc discharge, which has been generated from a surge generator to be input to input power terminals L, N and FG. To this end, the discharging unit 110 may include a first discharge pattern 111, a second discharge pattern 112, and a third discharge pattern 113.

The first discharge pattern 111 may include 1 a first pattern 111a and a second pattern 111b. The first pattern 111a is formed at the live terminal L among the input power terminals, and the second pattern 111b is formed at the neutral terminal N among the input power terminals having a predetermined distance from the first pattern 111a, such that a surge voltage between the live terminal L and the neutral terminal N may be arc-discharged.

The second discharge pattern 112 may include a third pattern 112a and a fourth pattern 111b. The third pattern 112a is formed at the live terminal L among the input power terminals, and the fourth pattern 112b is formed at the field ground terminal FG among the input power terminals having a predetermined distance from the third pattern 112a, such that a surge voltage between the live terminal L and the field ground terminal FG may be arc-discharged.

The third discharge pattern 113 may include a fifth pattern 113a and a sixth pattern 113b. The fifth pattern 113a is formed at the neutral terminal N among the input power terminals, and the sixth pattern 113b is formed at the field ground terminal FG among the input power terminals having a predetermined distance from the fifth pattern 113a, such that a surge voltage between the neutral terminal N and the field ground terminal FG may be arc-discharged.

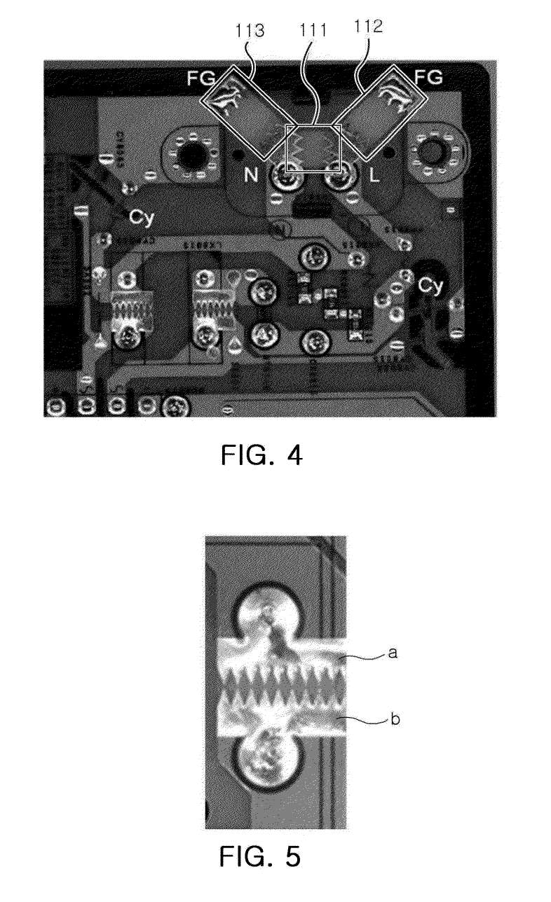

The above-described first to third discharge patterns 111, 112 and 113 may be formed at the input power terminals L, N and FG as shown in FIG. 4. The spaced distances between the first to third discharge patterns 111, 112 and 113 at which arc-discharge is made is kept at 3 mm or more, abrasion of patterns due to discharge energy between the patterns may be reduced.

The filter unit 120 may include a common mode filter 121, a fourth discharge pattern 112, a fifth inversion pattern 123, a first y capacitor C_{y1}, and a second y capacitor C_{y2}.

The common mode filter 121 may include a first inductor between the rear stage of the live terminal L among the input power terminals and the rectifying unit 130 and the power supplying unit 140, and a second inductor between the rear stage of the neutral terminal N among the input power terminals and the rectifying unit 130 and the power supplying unit 140, such that common mode electromagnetic interference at the live terminal L and the neutral terminal N among the input power terminals may be filtered.

The fourth discharge pattern 112 may include seventh and eighth patterns 112a and 122b. The seventh and eighth patterns 112a and 122b are formed at one terminal and the other terminal of the first inductor, respectively, and are spaced apart by a predetermined distance, such that a surge voltage in the live terminal L among the input power terminals may be discharged along a transfer path for a surge generated by the surge generator.

The fifth discharge pattern 123 may include ninth and tenth patterns 123a and 123b. The ninth and tenth patterns 123a and 123b are formed at one terminal and the other terminal of the second inductor, respectively, and are spaced apart by a predetermined distance, such that a surge voltage at the neutral terminal N among the input power terminals may be discharged at a transfer path for a surge generated by the surge generator.

Although the discharging unit 110 which is located at the foremost stage with respect to the input power terminal, may substantially reduce the energy of a surge current, it may not completely cancel a surge current depending on the amount of the energy of the surge current. In this case, it is expected that the energy of the surge current may be additionally reduced by the fourth discharge pattern 122 and the fifth discharge pattern 123 by arc discharge. To this end, the spacing between the seventh and eighth patterns 122a and 122b or the spaced distance between the ninth and tenth patterns 123a and 123b may be set to be 0.3 mm, and the portions of the patterns facing each other may be processed to have a toothed shape, as shown in FIG. 5. The closer the patterns are, the more the discharge operating voltage is reduced by additional discharge, such that it is expected that the more surge energy is reduced. Further, as the number of teeth that the patterns have increases; the more discharge paths are obtained at the time of discharging, such that discharge can be stably and regularly induced.

The first y capacitor C_{y1} and the second y capacitor C_{y2} may be connected between the live terminal L and the field ground terminal FG among the input power terminals, and between the neutral terminal N and the filed ground terminal FG, respectively, so as to filter common mode electromagnetic interference.

The rectifying unit 130 may rectify the power filtered by the filter unit 120. The power supplying unit 140 may convert the power rectified by the rectifying unit 130 into a predetermined power so as to supply it to components as necessary.

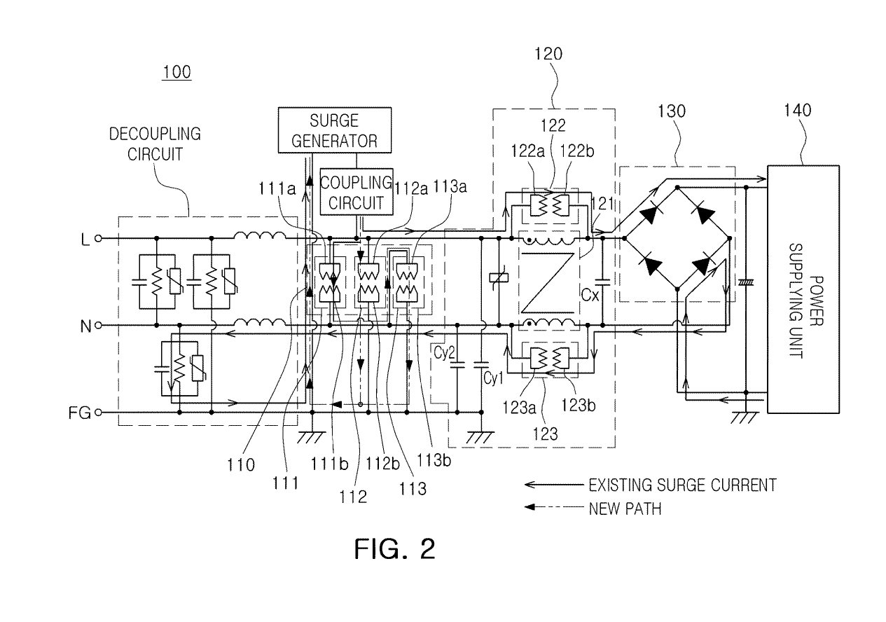

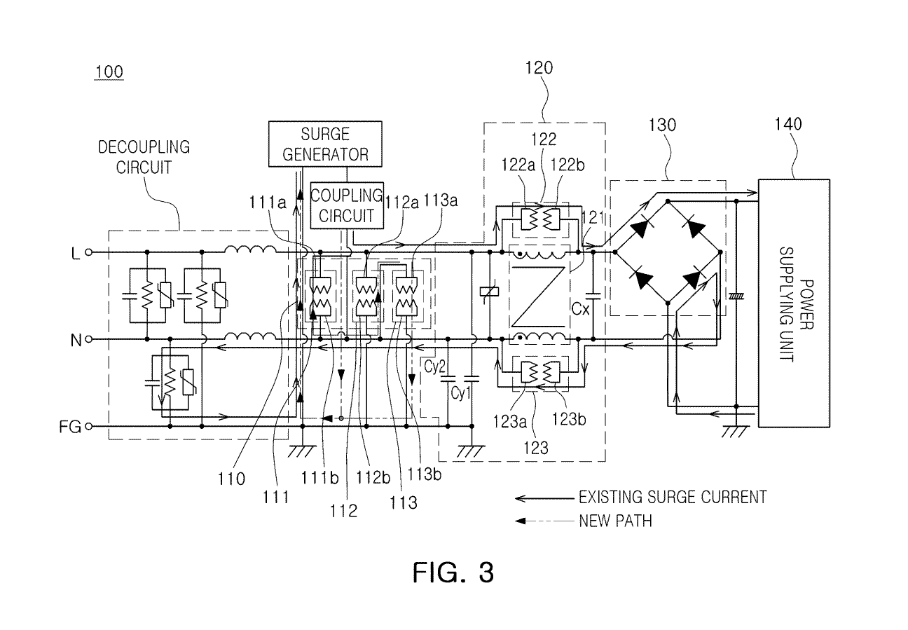

FIGS. 2 and 3 are circuit diagrams each schematically illustrating a discharge path for a surge of a power supply having a surge protection circuit according to an embodiment of the present invention.

Referring to FIGS. 2 and 3, the power supply 100 having the surge protection circuit according to the embodiment of the present invention may form a discharging unit 110 at the foremost stage with respect to input power terminals to which power is input, thereby reducing surge energy by arc discharge. Further, a surge current is distributed over transfer paths, thereby reducing the energy burden at the time of discharging. That is, as shown in FIGS. 2 and 3, a surge current from a surge generator is applied between the live terminal L—the field ground terminal FG and between the neutral terminal N—the field ground terminal FG, separate transfer paths for surge currents are formed as indicated by the arrows, thereby reducing an energy burden at the time of a discharge. (Here, the surge generator may include a coupling circuit and a decoupling circuit.) Specifically, as shown in FIG. 2, when a surge is applied to the live terminal L—the field ground terminal FG, a transfer path for a surge current between the live terminal L—the neutral terminal N and the neutral N—the field ground terminal FG, and a transfer path of a surge at the live terminal L—the field ground terminal FG may be formed. Further, as shown in FIG. 3, when a surge is applied to the neutral terminal N—the field ground terminal FG, a transfer path of a surge current between the live terminal L—the neutral terminal N and the live terminal N—the field ground terminal FG, and a transfer path of a surge at the neutral terminal N—the field ground terminal FG may be formed.

That is, by forming divided transfer paths for a surge current, an introduced high-frequency/low-frequency surge current may be significantly reduced, and the energy of a surge current may be distributed. Accordingly, a surge protection device such as a surge absorber or a varistor used in the related art is not required, such that manufacturing costs may be lowered and the area of a circuit may be saved.

Additionally, if the energy of a surge current is substantially but not completely reduced by the discharging unit 110, depending on the amount of the energy of the surge current, the first y capacitor C_{y1} and the second y capacitor C_{y2} provide transfer paths for the surge current so that the energy of the surge may be further reduced.

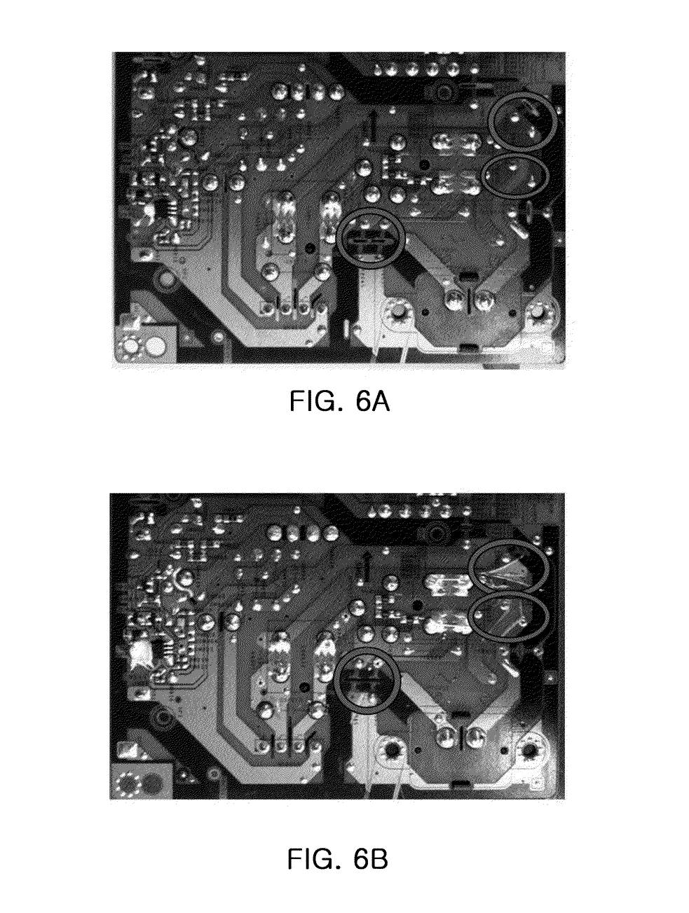

FIGS. 6A and 6B are photographs of printed circuit boards in which a power supply according to the related art and a power supply having a surge protection circuit according to an embodiment of the present invention are actually implemented, respectively.

Compared to the power supply according to the related art shown in FIG. 6A, the power supply having the surge protection circuit according to the embodiment of the present invention shown in FIG. 6B may prevent an unnecessary discharge and obtain a sufficiently spaced distance by way of removing unnecessary pads between patterns of discharge patterns.

As set forth above, according to embodiments of the present invention, as soon as a surge is introduced from alternating current power input terminals, it is bypassed to the ground and discharged, such that circuits at rear stages can be protected from the surge. Further, manufacturing costs can be lowered since no expensive surge absorber is used.

While the present invention has been shown and described in connection with the embodiments, it will be apparent to those skilled in the art that modifications and variations can be made without departing from the spirit and scope of the invention as defined by the appended claims.

What is claimed is:

1. A power supply having a surge protection circuit, comprising:
a discharging unit having discharge patterns disposed between power lines of input power terminals to discharge a surge voltage introduced into each of the power lines of the input power terminals; and
a power supplying unit converting the power input via the input power terminals into predetermined power to supply the converted power.

2. The power supply of claim 1, wherein the input power terminals includes a live terminal, a neutral terminal and a field ground terminal.

3. The power supply of claim 2, wherein the discharging unit includes:
a first discharge pattern arc-discharging a surge voltage between the live terminal and the neutral terminal;
a second discharge pattern arc-discharging a surge voltage between the live terminal and the field ground terminal; and
a third discharge pattern arc-discharging a surge voltage between the neutral terminal and the field ground terminal.

4. The power supply of claim 3, wherein the first discharge pattern includes:
a first pattern formed at the live terminal; and
a second pattern formed at the neutral terminal and spaced apart from the first pattern by a predetermined distance so as to arc-discharge a surge voltage.

5. The power supply of claim 3, wherein the second discharge pattern includes:
a third pattern formed at the live terminal; and
a fourth pattern formed at the field ground terminal and spaced apart from the third pattern by a predetermined distance so as to arc-discharge a surge voltage.

6. The power supply of claim 3, wherein the third discharge pattern includes:
a fifth pattern formed at the neutral terminal; and
a sixth pattern formed at the field ground terminal and spaced apart from the fifth pattern by a predetermined distance so as to arc-discharge a surge voltage.

7. The power supply of claim 3, further comprising a filter unit connected to the discharging unit so as to filter common mode noise in the power lines of the input power terminals.

8. The power supply of claim 7, wherein the filter unit discharges a surge voltage flowing in the live terminal and that flowing in the neutral terminal.

9. The power supply of claim 8, wherein the filter unit includes:
a common mode filter having a first inductor electrically connected to the live terminal and the power supplying unit and a second inductor electrically connected to the neutral terminal and the power supplying unit, and filtering electromagnetic interference in a common mode of the input power terminals and the power supplying unit;
a first y capacitor connected to the live terminal and the ground to filter electromagnetic interference in the common mode of the input power terminals and the power supplying unit;
a second y capacitor connected to the neutral terminal and the ground to filter electromagnetic interference in the common mode of the input power terminals and the power supplying unit;
a fourth discharge pattern having a seventh pattern formed at one terminal of the first inductor and an eighth pattern formed at the other end of the first inductor and spaced apart from the seventh pattern by a predetermined distance so as to arc-discharge a surge voltage flowing in the live terminal; and
a fifth discharge pattern having a ninth pattern formed at one terminal of the second inductor and a tenth pattern formed at the other end of the second inductor and spaced apart from the ninth pattern by a predetermined distance so as to arc-discharge a surge voltage flowing in the neutral terminal.

10. The power supply of claim 9, wherein the first y capacitor and the second y capacitor provide discharge paths for the surge voltage.

11. The power supply of claim 1, further comprising a rectifying unit rectifying the power from which electromagnetic interference has been filtered by the filter unit.

12. A power supply having a surge protection circuit, comprising:
a discharging unit having discharge patterns disposed between power lines of input power terminals to discharge a surge voltage introduced into each of the power lines of the input power terminals;
a filter unit connected to the discharging unit to filter common mode noise in the power lines of the input power terminals, and providing discharge paths for surge voltages flowing in the power lines of the input power terminals; and
a power supplying unit converting the filtered power into predetermined power to supply the converted power.

13. The power supply of claim 12, wherein the input power terminals includes a live terminal, a neutral terminal and a field ground terminal.

14. The power supply of claim 13, wherein the discharging unit includes:
a first discharge pattern having a first pattern formed at the live terminal, and a second pattern formed at the neutral terminal and spaced apart from the first pattern by a predetermined distance so as to arc-discharge a surge voltage between the live terminal and the neutral terminal;
a second discharge pattern having a third pattern formed at the live terminal, and a fourth pattern formed at the field ground terminal and spaced apart from the third pattern by a predetermined distance so as to arc-discharge a surge voltage between the live terminal and the field ground terminal; and
a third discharge pattern having a fifth pattern formed at the neutral terminal, and a sixth pattern formed at the field ground terminal and spaced apart from the fifth pattern by a predetermined distance so as to arc-discharge a surge voltage between the neutral terminal and the field ground terminal.

15. The power supply of claim 14, wherein the filter unit discharges a surge voltage flowing in the live terminal and that flowing in the neutral terminal.

16. The power supply of claim 15, wherein the filter unit includes :
a common mode filter having a first inductor electrically connected to the live terminal and the power supplying unit and a second inductor electrically connected to the neutral terminal and the power supplying unit, and filtering electromagnetic interference in a common mode of the input power terminals and the power supplying unit;
a first y capacitor connected to the live terminal and the ground to filter electromagnetic interference in the common mode of the input power terminals and the power supplying unit;
a second y capacitor connected to the neutral terminal and the ground to filter electromagnetic interference in the common mode of the input power terminals and the power supplying unit;
a fourth discharge pattern having a seventh pattern formed at one terminal of the first inductor and an eighth pattern formed at the other end of the first inductor and spaced apart from the seventh pattern by a predetermined distance so as to arc-discharge a surge voltage flowing in the live terminal; and
a fifth discharge pattern having a ninth pattern formed at one terminal of the second inductor and a tenth pattern formed at the other end of the second inductor and spaced apart from the ninth pattern by a predetermined distance so as to arc-discharge a surge voltage flowing in the neutral terminal.

17. The power supply of claim 16, wherein the first y capacitor and the second y capacitor provide discharge paths for the surge voltage.

18. The power supply of claim 12, further comprising a rectifying unit rectifying the power from which electromagnetic interference has been filtered by the filter unit.
